(19) United States
(12) Patent Application Publication
(10) Pub. No.: US 2010/0149094 A1
(43) Pub. Date: Jun. 17, 2010

(54) Snow Globe Interface for Electronic Weather Report

(76) Inventors: Steve Barnes, Madison, WI (US); Christopher W. Kelly, Madison, WI (US); Irene Cash, McFarland, WI (US)

Correspondence Address: BOYLE FREDRICKSON S.C., 840 North Plankinton Avenue, MILWAUKEE, WI, 53203, US

(21) Appl. No.: 12/605,800

(22) Filed: Oct. 26, 2009

Related U.S. Application Data
(60) Provisional application No. 61/108,355, filed on Oct. 24, 2008.

(51) Int. Cl. G09G 5/00; G06F 3/033

(52) U.S. Cl. 345/156; 715/863

(57) ABSTRACT

A portable computing device for displaying weather information. The device includes a transceiver configured to send and receive weather information, a display controller configured to generate a weather scene display including the weather information based on a received shaking input provide to the portable computing device and a display configured to present the generated weather scene display. The display controller is configured to display flitter configured to obscure the generated weather scene display during the receiving of the weather information and/or updating of the generated weather scene display.

### CROSS REFERENCE TO RELATED APPLICATIONS

This application claims the benefit of U.S. Provisional Application No. 61/108,355, filed Oct. 24, 2008, and incorporated herein in its entirety.

### BACKGROUND OF THE INVENTION

The present invention relates to a device for reporting weather forecasts. More particularly, the present invention relates to a wireless device providing a simplified and graphically compelling forecast presentation.

Snow globes are traditionally transparent hollow spheres containing a small sculpture, a clear liquid such as water or mineral oil, and small particles (flitter) that simulate snow. When the globe is shaken, the particles are agitated and swirl and fall in a manner simulating a snowstorm.

The snow globe has a long history dating at least from the Paris Universal exposition of 1878. The snow globes versatility in depicting a snowstorm in animated fashion has delighted countless generations. The snow globe captures at once our innate interest in the phenomenon of weather and our fascination with the miniature scene rendered inviolate within a protective globe.

### SUMMARY OF THE INVENTION

The present invention uses the metaphor of a snow globe for the delivery of forecast weather. Using modern wireless data communication techniques and computerized graphics, the magic of the snow globe is reproduced with animated weather (not just snow) revealing the future forecast.

One embodiment of the present invention relates to a portable computing device for displaying weather information. The device includes a transceiver configured to send and receive weather information, a display controller configured to generate a weather scene display including the weather information based on a received shaking input provide to the portable computing device and a display configured to present the generated weather scene display. The display controller is configured to display flitter configured to obscure the generated weather scene display during the receiving of the weather information and/or updating of the generated weather scene display.

### BRIEF DESCRIPTION OF THE DRAWINGS

FIG. 1 is a perspective view of the present invention implemented on a portable phone or the like;

FIG. 2 is a block diagram of the components of the phone of FIG. 1 including a microprocessor implementing a stored program connected to an accelerometer and wireless receiver;

FIG. 3 is a flow chart of the program implemented by the computer of FIG. 2;

FIGS. 4a-c are depictions of the snow globe on the screen of the device of FIG. 2 at various stages in the program of FIG. 3;

FIGS. 5a-c are examples of different flitter patterns that may be used for different seasonal occurrences;

FIG. 6 is a figure showing division of the animated elements into planes useful for customizable scenes; and

FIG. 7 is an elevational cross section of a dedicated device for implementing the present invention.

### DETAILED DESCRIPTION OF THE PREFERRED EMBODIMENT

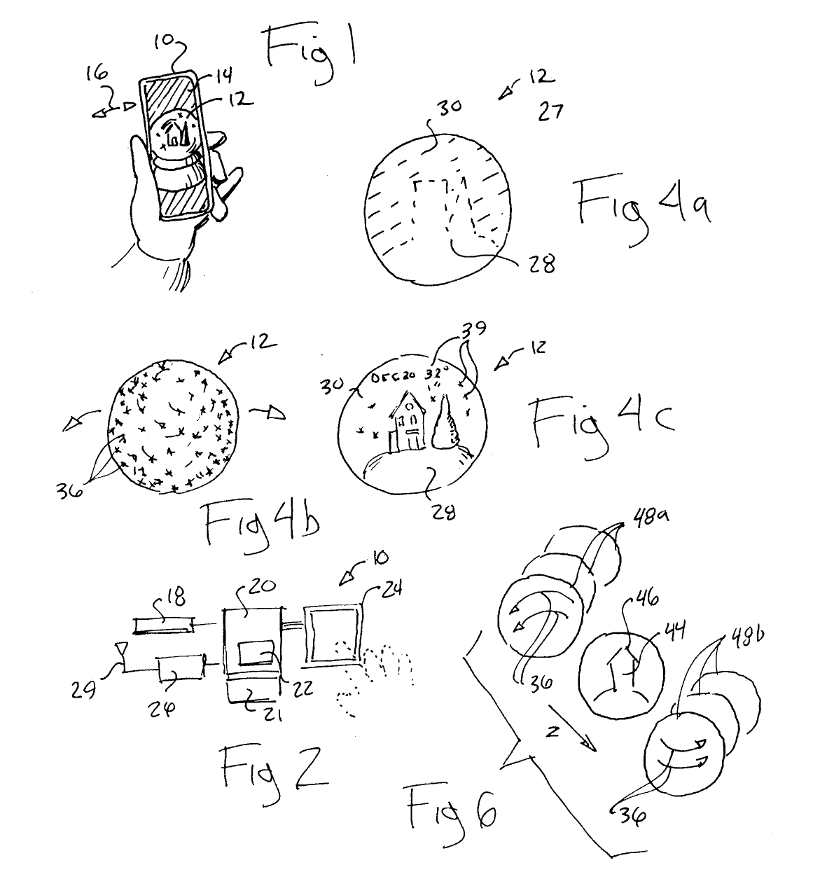

Referring now to FIG. 1, the present invention may be implemented on a cell phone 10 including computing capabilities, for example, the Apple iPhone, commercially available from the Apple Inc. of Cupertino, Calif. In this embodiment, a snow globe 12 is depicted graphically on a display screen 14 of the phone 10 to be activated by a shaking 16 of the phone. The shaking may be detected using accelerometer incorporated in the cell phone 10 as described below.

Referring now to FIG. 2, the phone 10, or a similar device suitable for use with the present invention, provides an accelerometer 18 communicating with a microcontroller 20 that may detect movement of the phone 10 to trigger a program 22 or one or more functions of program 22 contained in electronic memory within the microcontroller 20.

The microcontroller 20 may also communicate with a touchscreen 24 of a type known in the art allowing for both the display of the snow globe 12 and for the input of data by a user according to conventional touch techniques. Microcontroller 20 may also communicate with a battery 21 allowing portable use. The microcontroller 20 may also communicate with a wireless transceiver 26 having an antenna 29 for the exchange of data with an external network using a variety of communication standards including, for example, cell telephone standards protocols such as 3G and other wireless communication techniques such as those adhering to IEEE 802.11.

Referring now to FIG. 3, the program 22, when executed, may display a neutral scene as indicated by process block 25 and as shown in FIG. 4a being a two-dimensional rendering of the typical snow globe. This neutral scene 26 may provide for static scene elements 28, for example, a house and landscaping, and a neutral sky 30. In one embodiment, the sky 30 and scene elements 28 may be rendered in low saturation and with flat lighting to accentuate the magic of their transformation into a live scene when the globe (the cell phone 10) is shaken. Upon activation of the program 22, a wireless communication may occur using transceiver 26 to obtain forecast data and/or current weather conditions for a defined location. The location may be defined by the user to be the user's location or an arbitrary location. The location may be defined either using the device 10 or by means of a separate Internet connection with the remote weather server providing the weather data and storing user preferences and location information. A location of device 10, when used as the defined location, may be deduced by geo-location techniques, for example, from GPS data, wireless server locations or cell phone tower addresses and triangulation techniques or the like. The location may also be manually entered by the user using an input function of phone 10 to define a city and state, a zip code, a latitude/longitude, etc.

At process block 32, a shaking input is detected above a certain magnitude by threshold comparison of the signal from the accelerometer (shown in FIG. 2) upon which the program 22 proceeds to process block 34 at which the current date is evaluated (as available from the wireless transmitter 26 or an internal clock of device 10) to determine a season and an appropriate seasonal flitter 36 as will be described. According to an alternative embodiment, the shaking input may be received based on a touch screen input (i.e., a user may use a touch screen input of device 10 to “grab” scene 26 and move their finger back and forth to simulate the shaking of scene 26.)

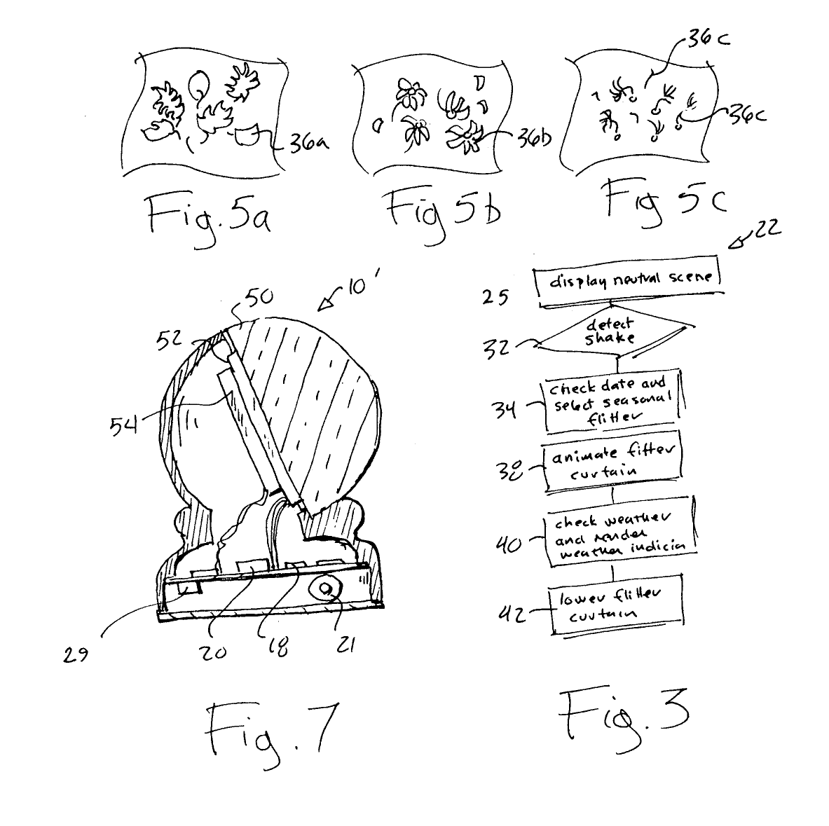

Referring momentarily to FIGS. 5a-c, in the winter, the flitter 36 may be snow, as is traditional; however, other flitters 36 may be used, for example leaves 36a for the fall, flowers 36b for the spring, dandelion seeds or grass clippings 36c for the summer, etc. Flitter 36 may be any graphical element selected based on a time of year, predicted, current and/or previous weather information, etc. and displayed within scene 26. Flitter 36 may be generated using a plurality of flitter elements, wherein each element is configured to move within a defined space in accordance with defined flitter movement controls. The flitter movement controls may include a gradual settling of all of the flitter elements to a defined area of the scene 26, a continuous, random swirling, concerted movement with other flitter elements, including collision detection, etc. The number of flitter elements are their movement may be selected dependent on the degree to which the underlying scene 26 is to be obscured, as described below.

Flitter 36 may further be associated with a sound file configured to be played during the display of the flitter 36. For example, the sound of blowing wind or rustling leaves may be configured to be played when leaves 36a are being displayed. The associated sound may be configurable by the user, such that the user can select one or more sound files that are stored on the device 10 to be associated with the displayed flitter 36.

As shown in FIG. 4b, at process block 38, the flitter is animated, for example by the playing of the pre-stored animated sequence or, in more advanced devices, by a three-dimensional procedural animation to obscure the scene 26 by a dense cloud of swirling flitter 36. At this time, as indicated by process block 40, a weather forecast or current weather condition is determined from a previous wireless communication to the transceiver 26 and a new rendering of the scene 26 and sky 30 is developed with appropriate weather related indicia 39. This new scene 26 and sky 30 may be a pre-rendered animation keyed to the selected scene 26 or may be procedurally animated. However, downloading the data and preparing the scene may take a period of time, during which time, the flitter 36 may be configured to entirely obscure scene 26. Once the new scene 26 and sky 30 are prepared, the flitter curtain is lowered, as indicated by process block 42, to reveal the scene as shown in FIG. 4c. Lowering the flitter curtain may include gradually lessening the number of flitter elements (e.g., reducing the number of snowflakes being displayed), allowing the flitter elements to settled in a defined area of scene 26 (e.g., allowing snowflakes to settle to the bottom of scene 26), etc. The number of elements may be lowered until zero is reached or until a determined amount that will not significantly obscure scene 26 are displayed. The weather related indicia 39 depicted in the new scene 26 and sky 30 may include, for example, sky color, animated weather conditions including clouds and precipitation, seasonally appropriate indications of wind (moving leaves, etc.) in addition to alphanumeric descriptions of quantitative weather data including the date, temperature, precipitation amount, barometric pressure, wind direction, precipitation chance and the like. This latter data is added to the scene from the received weather information by text overlay or the like. The weather indicia and other features of the scene may optionally “bounce” when the snow globe is shaken a second time within a predetermined time.

In the preferred embodiment, a variety of different scenes 28 may be selected by the user, for example downloaded in prerendered form, each representing a 3-D graphical model in which the flitter 36 is accurately animated using calculated physics and scene boundary detection to promote a realistic and dynamic view of swirling flitter 36.

In another preferred embodiment, the received and downloaded weather information may include current weather information, a weather forecast, etc. Program 22 may further be configured to provide an interface allowing a user to change the weather information being displayed. For example, the program 22 may be configured to change from a current weather display to a forecasted weather display, from a weather forecast for a first day to a weather forecast for a second day, etc. upon receiving an input from the user.

Alternatively, as shown in FIG. 6, the user may be allowed to insert, for example, a snapshot 44 for example of their own home or friends or family and to trim about the snapshot 44 to create one or more masks 46. The flitter 36 in this case may be rendered as an animated swirling sequence 48a and 48b in planes that can be placed along the z-buffer axis of the graphics buffer flanking each of the masks 46 to promote a sense of three-dimensional flow of flitter about each of the masks 46.

Referring now to FIG. 7, it will be understood that a dedicated weather forecasting snow globe 10′ can be produced using the same functional blocks as shown in FIG. 2 but placing them in a conventional snow globe structure, for example, including a hemispherical lens 50 of the type used on a paperweight backed by a display screen 52 and backlight 54. In this case the backlight intensity may be adjusted or turned off entirely until the globe is shaken. It will be understood that other display systems can be used, for example, those employing projections on rotating disks or screens or on a hemispherical back projection screen, or holographic techniques that are not commercially practical as yet but are technologically well within the understanding of those of ordinary skill in the art.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

We claim:

1. A portable computing device for displaying weather, comprising:
a transceiver configured to send and receive weather information;
a display controller configured to generate a weather scene display including the weather information based on a received shaking input provide to the portable computing device; and
a display configured to present the generated weather scene display,
wherein the display controller is configured to display flitter configured to obscure the generated weather scene display during the receiving of the weather information and/or updating of the generated weather scene display.

2. The portable computing device of claim 1, wherein the display controller is further configured to select the flitter being displayed based on a time of year.

3. The portable computing device of claim 1, wherein the display controller is further configured to select the flitter being displayed based on weather information.

4. The portable computing device of claim 1, wherein the display controller is further configured to play a sound associated with the flitter being displayed.

5. The portable computing device of claim 1, wherein the displayed flitter includes a plurality of flitter elements and the number of flitter elements being displayed decreases over a defined time period based on a predicted time to completion of the receiving of the weather information and/or updating of the generated weather scene display.

6. The portable computing device of claim 1, wherein the displayed flitter includes a plurality of flitter elements and flitter elements moved to a defined area of the weather scene display based on the completion of the receiving of the weather information and/or updating of the generated weather scene display.

7. The portable computing device of claim 1, wherein the display controller is configured to modify the weather information being used to generate the weather scene display based on a second received shaking input.

8. A computer-implemented method for displaying weather, comprising:
requesting weather information using a transceiver based on a received shaking input;
receiving updated weather information;
generating a weather scene display including the updated weather information;
displaying flitter configured to obscure a display during the receiving of the weather information and/or generation of the weather scene display; and
displaying the generated weather scene display.

9. The computer-implemented method of claim 8, wherein the flitter being displayed is selected based on a time of year.

10. The computer-implemented method of claim 8, wherein the flitter being displayed is selected based on weather information.

11. The computer-implemented method of claim 8, further including playing a sound associated with the flitter being displayed.

12. The computer-implemented method of claim 8, wherein the displayed flitter includes a plurality of flitter elements and the number of flitter elements being displayed decreases over a defined time period based on a predicted time to completion of the receiving of the weather information and/or updating of the generated weather scene display.

13. The computer-implemented method of claim 8, wherein the displayed flitter includes a plurality of flitter elements and flitter elements moved to a defined area of the weather scene display based on the completion of the receiving of the weather information and/or updating of the generated weather scene display.

14. The computer-implemented method of claim 8, further including modifying the weather information used to generate the weather scene display being displayed based on a second received shaking input.
